(19) United States
(12) Patent Application Publication
(10) Pub. No.: US 2015/0043825 A1
(43) Pub. Date: Feb. 12, 2015

(54) ELECTRONIC DEVICE, METHOD AND COMPUTER-READABLE MEDIUM

(71) Applicant: Kabushiki Kaisha Toshiba, Tokyo (JP)

(72) Inventor: Chikashi Sugiura, Hamura-shi (JP)

(73) Assignee: Kabushiki Kaisha Toshiba, Tokyo (JP)

(21) Appl. No.: 14/269,012

(22) Filed: May 2, 2014

(30) Foreign Application Priority Data
Aug. 6, 2013 (JP) 2013-163668

(51) Int. Cl. G06F 3/0488

(52) U.S. Cl. CPC G06F 3/04883
USPC 382/189

(57) ABSTRACT

An electronic device includes an input and a display controller. The input is configured to receive information of a handwritten table. Cells in the table include strokes. The display controller displays either one of a first symbol and a second symbol as a recognition result of a first stroke in a first cell of the table at a position of the first cell in response to an operation for formatting the table. One of the first symbol and the second symbol is determined to be displayed according to one of at least one of second strokes in another cell in a same row as the first cell and at least one of third strokes in another cell in a same column as the first cell.

### CROSS-REFERENCE TO RELATED APPLICATION

This application is based upon and claims the benefit of priority from Japanese Patent Application No. 2013-163668, filed on Aug. 6, 2013; the entire contents of which are incorporated herein by reference.

### FIELD

Embodiments described herein relate generally to an electronic device, a method and a computer-readable medium.

### BACKGROUND

In recent years, various kinds of electronic devices such as tablets (tablet computers), PDAs, smartphones have been developed. Most of such the kinds of electronic devices include a touch screen for facilitating the input operation by a user, respectively.

A user can instruct, to the electronic device by touching one of menus or objects displayed on the touch screen display, the execution of a function in association with the menu or object thus touched.

### BRIEF DESCRIPTION OF THE DRAWINGS

FIG. 1 is a perspective view showing the external appearance of an electronic device according to an embodiment.

FIG. 2 is a diagram showing a cooperating operation between the electronic device according to the embodiment and an external device.

FIG. 3 is a diagram showing an example of a handwritten text being handwritten on the electronic device according to the embodiment.

FIG. 4 is a diagram showing an example of chronological information stored in the electronic device according to the embodiment.

FIG. 5 is a block diagram showing an example of the configuration of the electronic device according to the embodiment.

FIG. 6 is a block diagram showing an example of the functional configuration of a digital notebook application program.

FIG. 7 is a diagram showing an example of a table described in a handwritten manner.

FIG. 8 is a diagram showing an example of the shaping result of the table described in the handwritten manner.

FIGS. 9A and 9B are diagrams showing an example of tables described in a handwritten manner.

### DETAILED DESCRIPTION

According to one embodiment, an electronic device includes an input and a display controller. The input is configured to receive information of a handwritten table. Cells in the table include strokes. The display controller displays either one of a first symbol and a second symbol as a recognition result of a first stroke in a first cell of the table at a position of the first cell in response to an operation for formatting the table. One of the first symbol and the second symbol is determined to be displayed according to one of at least one of second strokes in another cell in a same row as the first cell and at least one of third strokes in another cell in a same column as the first cell.

Various embodiments will be described hereinafter with reference to the accompanying drawings.

An embodiment of this invention will be explained.

### Embodiment

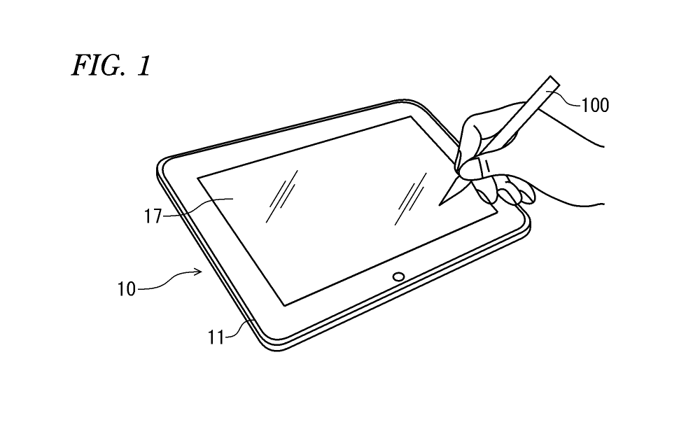

FIG. 1 is a perspective view showing the external appearance of an electronic device according to the embodiment. This electronic device is a type capable of inputting data in a handwriting manner using a pen or a finger, for example. This electronic device is a tablet, a notebook-size personal computer, a smartphone, a PDA or a large sized display used in place of a whiteboard, for example. Hereinafter, the explanation will be made as to a case that this electronic device is a tablet 10. The tablet 10 is an electronic device also called as a tablet computer or a slate computer. The tablet 10 includes a main body 11 and a touch screen display 17. The touch screen display 17 is attached on the upper surface of the main body 11 in an overlapped manner.

The main body 11 has a thin box-shaped case. The touch screen display 17 may be any type so long as it serves not only as a display capable of displaying electronic data in a color or black-and-white mode but also as an input device capable of detecting the position of a contact point on a screen (surface) by a pen or a finger. The touch screen display 17 includes a flat panel display and a sensor for detecting the contact position of a pen or a finger on the screen of the flat panel display, for example. The flat panel display may be a liquid crystal display (LCD) or an organic EL display, for example. The sensor may be an electrostatic-type touch panel or an electromagnetic-induction type digitizer, for example. Hereinafter, it is supposed that two kinds of the sensors, that is, both the digitizer and the touch panel are incorporated into the touch screen display 17. Each of the digitizer and the touch panel is provided so as to cover the screen of the flat panel display.

The touch screen display 17 can detect not only the touch operation on the screen using a finger but also the touch operation on the screen using a pen 100. The pen 100 may be an electromagnetic-induction type pen, for example. A user can input characters, graphics and so on, in handwriting on the touch screen display 17 by using an external object (pen 100 or finger). Strokes may be any type so long as they are a locus (brushstroke) drawn in handwriting. For example, strokes are a locus drawn and inputted on the touch screen display 17 by using the external object, or a locus drawn and inputted in handwriting by using another user interface. For example, one stroke corresponds to a locus of the movement of the external object until the separation from the screen after the touching on the screen by the external object. The touch screen display 17 displays the loci of movements of the external object, that is, handwritten strokes drawn on the screen in real time.

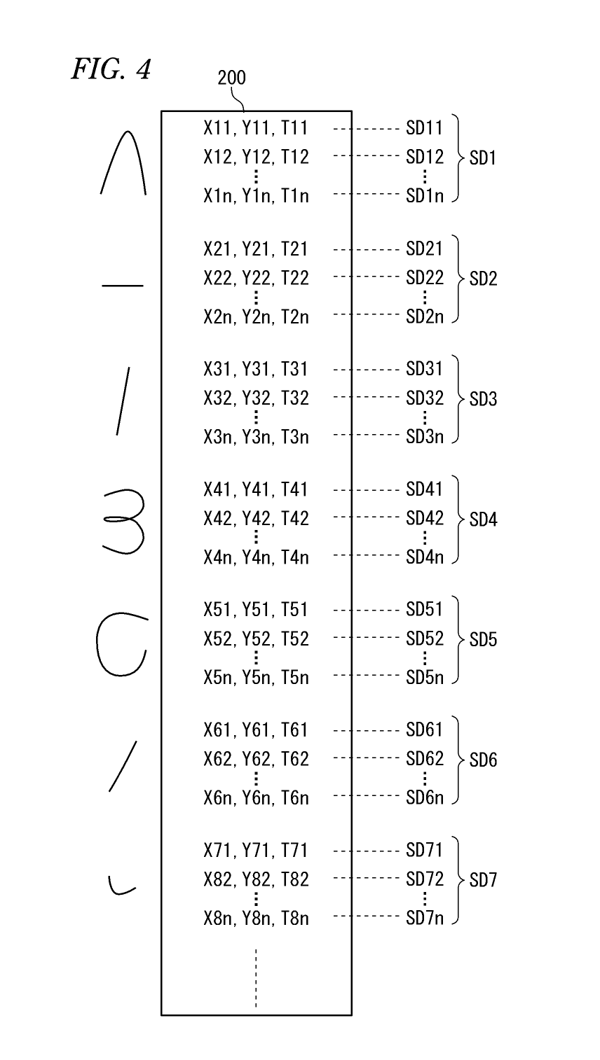

Electronic data of a handwritten text (hereinafter, merely referred to a handwritten text) is a set of information of many strokes corresponding to handwritten characters or graphics etc. The handwritten text is stored in a recording medium contained within the tablet 10, another electronic device possessed by a user, a server or a cloud computing. In this embodiment, the handwritten text may be an image capable of specifying respective strokes (loci) (hereinafter referred to image data), data capable of specifying a coordinate sequence of respective strokes (loci) (hereinafter referred to stroke data), or chronological information representing stroke data of respective strokes and an order relation among the respective strokes. The image data may minimally be an image capable of specifying each of a plurality of strokes. That is, the image data at least may be an image capable of specifying the shape of each of the strokes and may contain information such as thicknesses and colors thereof. The stroke data may minimally be data capable of specifying a coordinate sequence of each of strokes (loci). For example, a piece of stroke data corresponds to one stroke and contains coordinate data corresponding to respective dots on the locus of this stroke. The chronological information may minimally be data capable of discriminating handwritten order (stroke order) of a plurality of strokes and also capable of specifying each of the strokes. Details of the chronological information will be explained later with reference to FIG. 4. The order of pieces of stroke data contained in the chronological information may represent handwritten order, that is, stroke order of respective strokes. The chronological information may further contain information of handwritten order (stroke order) of strokes corresponding to respective pieces of stroke data, or may further contain times at which strokes corresponding to respective pieces of stroke data are written. Hereinafter, although the explanation will be made as to a case where the handwritten text is stored as the chronological information, the handwritten text may be stored as image data or may be stored in a mode where handwritten order (stroke order) of a plurality of strokes can not be discriminated.

The tablet 10 can display on the screen thereof a plurality of strokes represented by the chronological information. The tablet 10 has an editing function. The editing function may contain a function of deleting or moving an arbitrary stroke(s) or an arbitrary handwritten character(s) etc. within a handwritten text being displayed and a function of deleting history of some handwriting operations, in accordance with an operation of a user using an “eraser” tool, an area designation tool, or other various kinds of tools etc.

The chronological information (handwritten text) may be managed as a single page or plural pages. The chronological information (handwritten text) may be recorded in a manner of being partitioned on an area (page) unit basis fit into the screen. The page size may be variable. Since the page size can be expanded to an area larger than a single screen, the handwritten text larger than the screen size can be treated as a single page. When the entirety of a single page can not be displayed on the screen at once, the page may be shrunk or may be scrolled so as to move a portion of this page to be displayed within the screen in a longitudinal/transverse direction.

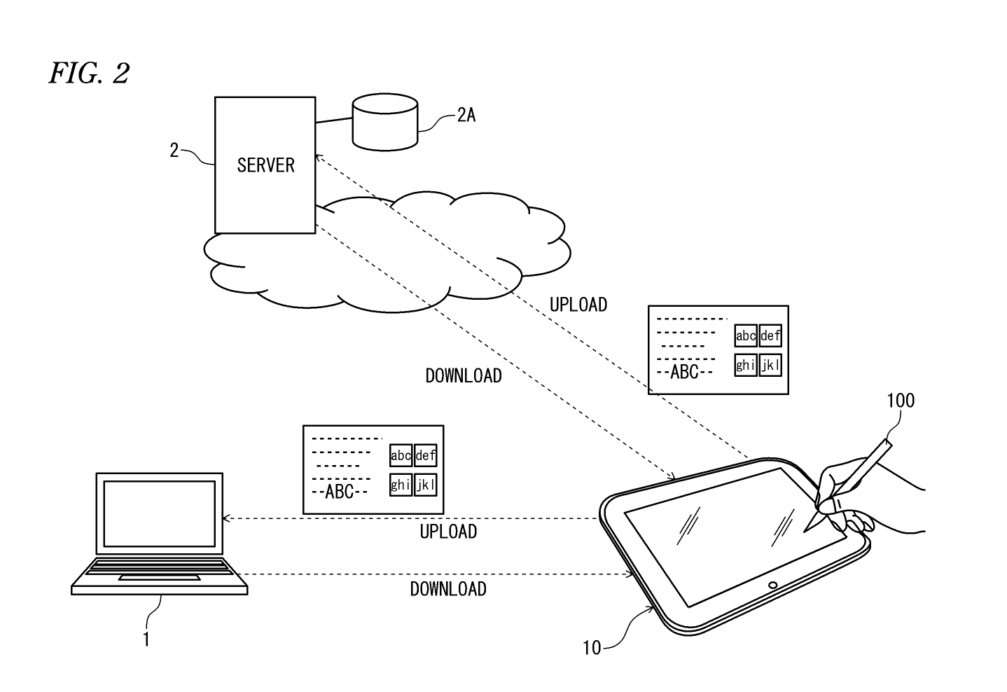

FIG. 2 shows an example of a cooperating operation between the tablet 10 and an external device. The tablet 10 can cooperate with a personal computer 1 and a cloud computing. The tablet 10 includes a communication device such as a wired LAN, a wireless LAN, a cellular communication system (3G, LTE, LTE-advanced), and hence can communicate with the personal computer 1 or a server 2. The server 2 may be arranged to be able to execute an online storage service or other various kinds of cloud computing services.

The personal computer 1 includes a storage device such as a hard disk drive (HDD), a semiconductor memory (NAND memory, NOR memory). The tablet 10 can transmit the chronological information (handwritten text) to the personal computer 1 via a network and record the chronological information in the storage device of the personal computer 1 (upload). In order to ensure a secure communication between the tablet 10 and the personal computer 1, an authentication processing may be performed between the personal computer 1 and the tablet 10 at the time of starting a communication. Thus, even in a case where a remaining capacity of the storage within the tablet 10 is small, the tablet 10 can deal with much chronological information (handwritten text) or chronological information (handwritten text) of a large capacity. The tablet 10 can read arbitrary at least one piece of the chronological information recorded in the storage device of the personal computer 1 (download) and display strokes shown by the chronological information thus read on the screen of the display 17.

The tablet 10 may communicate with the server 2 in the could computing which provides a storage service etc. The tablet 10 can transmit the chronological information (handwritten text) to the server 2 via the network and record in the storage device 2A of the server 2 (upload). The tablet 10 can read arbitrary piece of the chronological information recorded in the storage device 2A of the server 2 (download) and display respective loci of the strokes represented by the arbitrary piece of the chronological information thus read on the screen of the display 17 of the tablet 10.

In this manner, according to the embodiment, a recording medium for storing the chronological information (handwritten text) may be any type so long as it is a storage device accessible from the tablet 10. For example, the recording medium may be the storage device within the tablet 10, the storage device within the personal computer 1 or the storage device within the server 2.

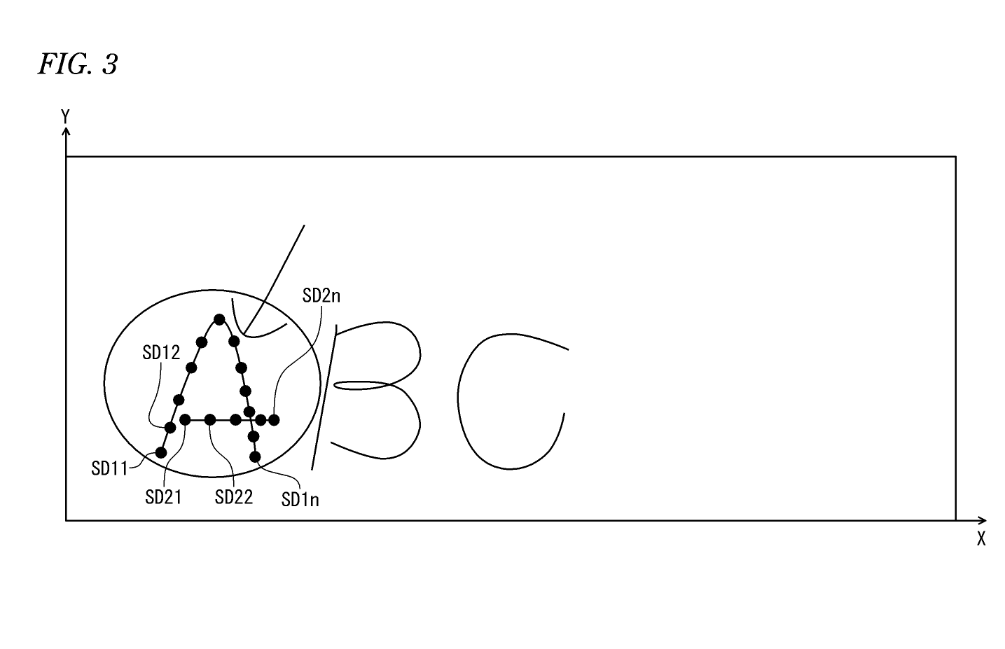

The explanation will be made with reference to FIGS. 3 and 4, as to a relation between strokes (characters, marks, graphics, tables etc) handwritten by a user and chronological information thereof. FIG. 3 shows an example of a handwritten text written on the touch screen display 17 by using the pen 100 etc. In a handwritten text, other characters or graphics may be further handwritten on characters or graphics having been handwritten already. In FIG. 3, it is supposed that a character sequence “ABC” is handwritten in the order of “A”, “B” and “C”, and thereafter an arrow is handwritten near the handwritten character “A”.

FIG. 4 shows chronological information 200 corresponding to the handwritten text of FIG. 3. The chronological information includes plural pieces of stroke data SD1, SD2, SD7. In an example of the chronological information 200 shown in FIG. 4, the pieces of stroke data SD1, SD2, - - - SD7 are arranged in the handwritten order (chronological order) of the strokes.

The handwritten character “A” is represented by two strokes (a locus of a shape “ [symbol] ” and a locus of a shape “-”), that is, two loci handwritten using the pen 100 etc. The locus of the shape “ [symbol] ” handwritten at first by the pen 100 is sequentially sampled in real time with the same time interval, for example, to thereby obtain the piece of stroke data SD1 (chronological coordinates SD11, SD12, - - - , SD1n) of the shape “ [symbol] ”. In the similar manner, the locus of the shape “-” handwritten next by the pen 100 is sequentially sampled to thereby obtain the piece of stroke data SD2 (chronological coordinates SD21, SD22, - - - , SD2n) of the shape “-”. The handwritten character “B” is represented by the two pieces of stroke data SD3, SD4 (chronological coordinates SD31 - - - SD3n, SD41 - - - SD4n). The handwritten character “C” is represented by the piece of stroke data SD5 (chronological coordinates SD51 - - - SD5n). The handwritten arrow is represented by the two pieces of stroke data SD6, SD7 (chronological coordinates SD61 - - - SD6n, SD71 - - - SD7n).

Each of the respective pieces of stroke data includes a coordinate data sequence (chronological coordinates) corresponding to one stroke, that is, a plurality of coordinates respectively corresponding to plural points on the locus of the one stroke. For example, as to the handwritten character “A”, the piece of stroke data SD1 includes a coordinate data sequence (chronological coordinates) corresponding to plural points on the locus of the shape “ [symbol] ” of the handwritten character “A”, that is, n-pieces of coordinate data SD11, SD12, - - - SD1n. The piece of stroke data SD2 includes a coordinate data sequence corresponding to plural points on the locus of the shape “-” of the handwritten character “A”, that is, n-pieces of coordinate data SD21, SD22, - - - SD2n. The number (n) of pieces of the coordinate data may differ at every piece of stroke data.

Each of respective pieces of the coordinate data represents an X-coordinate and a Y-coordinate corresponding to one point within the corresponding locus. For example, the piece of coordinate data SD11 represents the X-coordinate (X11) and the Y-coordinate (Y11) at the start point of the stroke of the shape “ [symbol] ”. The piece of coordinate data SD1n represents the X-coordinate (X1n) and the Y-coordinate (Y1n) at the end point of the stroke of the shape “ [symbol] ”.

Further, each of respective pieces of the coordinate data may contain time stamp information T corresponding to a time at which the point corresponding to the piece of coordinate data is handwritten. The handwritten time may be an absolute time (year, month, date, time, minute and second, for example) or a relative time with reference to a certain time. For example, each of respective pieces of the stroke data may be added with an absolute time (year, month, date, time, minute and second, for example) at which a corresponding stroke is started to be handwritten, as the time stamp information. Further, each of respective pieces of the coordinate data within each of respective pieces of the stroke data may be added with a relative time representing a difference from the absolute time, as the time stamp information T. Time relationship among the strokes can be represented more accurately by the respective pieces of the coordinate data (chronological information) each containing the time stamp information T.

Further, each of respective pieces of the coordinate data may contain information (Z) representing a writing pressure. In this case, since each of respective pieces of the coordinate data (chronological information) containing the information (Z) representing a writing pressure represents accurately a habit of a person as to the handwritten stroke, a person of a handwritten stroke can be specified accurately.

Since a handwritten text is stored as the chronological information 200 constituted by a set of chronological pieces of stroke data, the handwritten text can be treated irrespective of kinds of languages of the handwritten text. Thus, this embodiment can be used commonly in various countries of different languages.

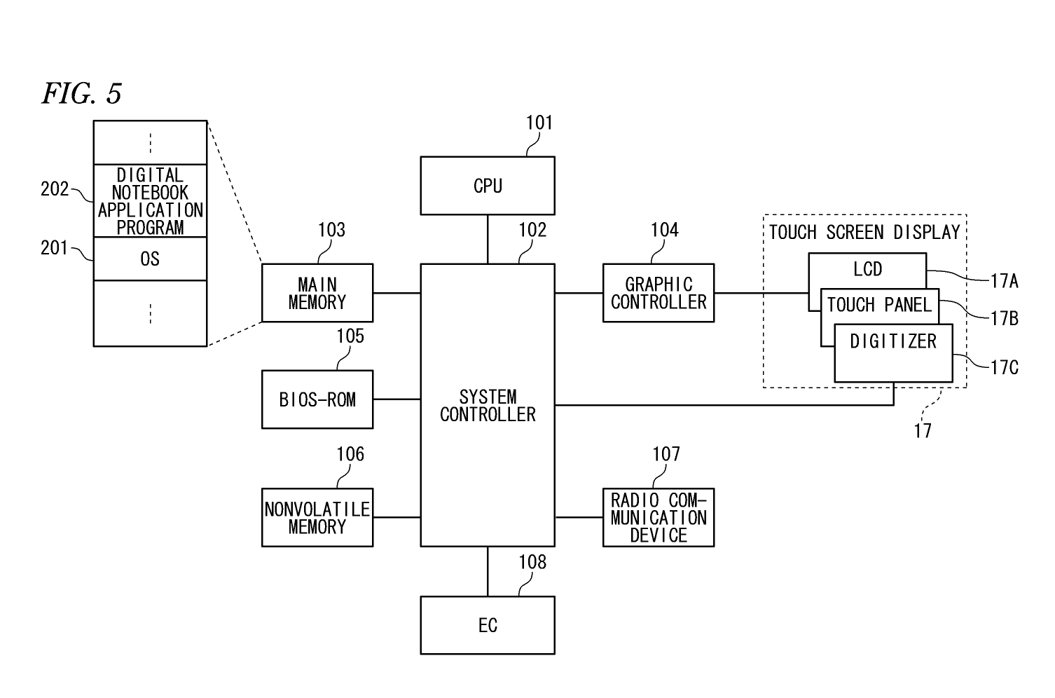

FIG. 5 is a diagram showing an example of the system configuration of the tablet 10. As shown in FIG. 5, the tablet 10 includes a CPU 101, a system controller 102, a main memory 103, a graphic controller 104, a BIOS-ROM 105, a nonvolatile memory 106, a radio communication device 107 and an embedded controller (EC) 108 etc.

The CPU 101 is a processor for controlling the operations of various kinds of modules within the tablet 10. The CPU 101 executes various kinds of softwares loaded into the main memory 103 from the nonvolatile memory 106 as a storage device. These softwares contain an operating system (OS) 201 and various kinds of application programs. The application programs contain a digital notebook application program 202. The digital notebook application program 202 is used to realize a function of preparing and displaying the aforesaid handwritten text, a function of editing the handwritten text, a function of searching brushstroke, a function of recognizing characters/graphics etc. The CPU 101 also executes a basic input/output system (BIOS) stored in the BIOS-ROM 105. The BIOS is a program for controlling hardware.

The system controller 102 is a device for connecting between the local buses of the CPU 101 and the various kinds of components. The system controller 102 contains a memory controller for controlling the accessing to the main memory 103. The system controller 102 also has a function of executing the communication with the graphic controller 104 via a serial bus of the PCI EXPRESS standard, for example.

The graphic controller 104 is a display controller for controlling an LCD 17A used as the display monitor of the tablet 10. A display signal generated by the graphic controller 104 is sent to the LCD 17A. The LCD 17A displays a screen image based on the display signal. A touch panel 17B and a digitizer 17C are disposed on the LCD 17A. The touch panel 17B is an electrostatic-type pointing device for inputting data on the screen of the LCD 17A. The touch panel 17B detects a contact position and the movement of the contact position etc. on the screen touched by a finger. The digitizer 17C is an electromagnetic-induction type pointing device for inputting data on the screen of the LCD 17A. The digitizer 17C detects a contact position and the movement of the contact position etc. on the screen touched by the pen 100.

The radio communication device 107 executes radio communication such as wireless LAN, cellular communication. The tablet 10 can obtain a handwritten text via the radio communication device 107. The EC 108 is a one-chip microcomputer having an embedded controller for power management. The EC 108 has a function of turning on and off the tablet 10 in accordance with the operation of a power button by a user.

The tablet 10 may further contain a camera (not shown) and may be connectable to a scanner (not shown). In this case, since a handwritten text can be photographed or imaged by the camera or the scanner, the tablet 10 can obtain image data of the handwritten text.

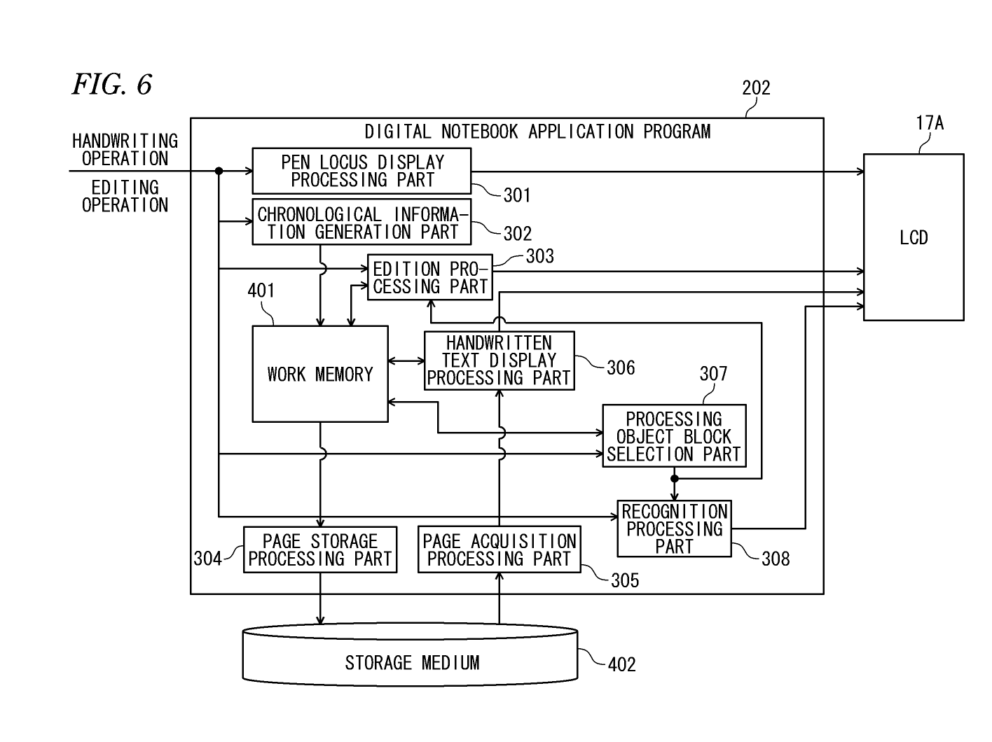

Next, the functional configuration of the digital notebook application program 202 will be explained with reference to FIG. 6. The digital notebook application program 202 includes a pen locus display processing part 301, a chronological information generation part 302, an edition processing part 303, a page storage processing part 304, a page acquisition processing part 305, a handwritten text display processing part 306, a processing object block selection part 307, a recognition processing part 308 etc. These functional blocks are realized by the CPU 101 which executes the digital notebook application program 202.

The digital notebook application program 202 performs preparation, display, edition etc. of a handwritten text by using event information etc. inputted via the touch screen display 17. The touch screen display 17 detects the generation of an event such as “touch”, “move (slide)”, “release” etc. The “touch” is an event representing that the external object is made in contact with the screen. The “move (slide)” is an event representing that, while the external object is being made in contact with the screen, the contact position is moved on the screen. The “release” is an event representing that the external object is separated from the screen.

Each of the pen locus display processing part 301 and the chronological information generation part 302 receives the event “touch” or “move (slide)” generated from the touch screen display 17 to thereby detect a handwriting input operation. The “touch” event includes the coordinate of the contact position. The “move (slide)” event includes the coordinates of the contact positions at the start of the movement, at the end of the movement and during the movement. Each of the pen locus display processing part 301 and the chronological information generation part 302 receives a coordinate sequence corresponding to the locus of the movement of the contact position from the touch screen display 17.

The pen locus display processing part 301 displays the loci of the respective strokes on the screen of the LCD 17A within the touch screen display 17 based on the coordinate sequence received from the touch screen display 17. The pen locus display processing part 301 displays the loci of the pen 100 while the pen 100 is made in contact with the screen, that is, the loci of the respective strokes on the screen of the LCD 17A.

The chronological information generation part 302 generates the aforesaid chronological information having the structure described in detail with reference to FIG. 4, based on the coordinate sequence received from the touch screen display 17. The chronological information generation part 302 may temporally stores the chronological information, that is, the coordinates and the time stamp information corresponding to respective points of the strokes, in a work memory 401.

The page storage processing part 304 stores the chronological information thus generated into a storage medium 402 as a handwritten text (handwritten page). As described above, the storage medium 402 may be the storage device within the tablet 10, the storage device within the personal computer 1, or the storage device within the server 2.

The page acquisition processing part 305 reads an arbitrary piece of the chronological information stored in the storage medium 402 and sends to the handwritten text display processing part 306. The handwritten text display processing part 306 displays the loci of the respective strokes on the screen as a handwritten page, based on the piece of the chronological information thus sent.

The edition processing part 303 executes a processing for editing a handwritten page being displayed. The edition processing part 303 executes the editing processing such as deletion or movement of at least one stroke among the plural strokes being displayed, in accordance with an editing operation performed by a user on the touch screen display 17. When a user selects a menu such as “deletion” or “movement” from the edition menus, for example, the edition processing part 303 executes the processing such as the deletion or movement with respect to the stroke(s) to be processed. A user can delete arbitrary one(s) of plural strokes being displayed, by using the “eraser” tool, an opposite end of the pen 100, a tapping by the pen 100, for example. A user can move an arbitrary one of the strokes being displayed by subjecting the stroke to be processed to a drag-and-drop operation, for example, using the external object. The edition processing part 303 updates this chronological information so as to reflect the result of this editing processing. In the chronological information, the chronological coordinates of the stroke(s) having been moved may be updated automatically in accordance with the position of the movement destination. An operation history representing that the chronological coordinates of the stroke(s) having been moved are changed may be added to the chronological information. The chronological coordinate(s) of the stroke(s) having been deleted may be deleted. In this case, an operation history representing that the chronological coordinates of the stroke(s) having been deleted are deleted may be added to the chronological information.

The processing object block selection part 307 executes a processing for selecting the entirety or a part of a handwritten page being displayed. The processing object block selection part 307 can execute a processing for selecting at least one of plural strokes being displayed, in accordance with an area selected by a user on the screen of the touch screen display 17. The processing object block selection part 307 can determine an area or a stroke(s) to be selected, in accordance with the movement of the hand of a user or the pen on the screen of the touch screen display 17, a touch of a stroke thereon, or a double-touch in which a stroke is touched on the screen continuously within a predetermine time, for example.

The recognition processing part 308 performs a shaping processing of a handwritten text (strokes) with respect to the entirety or a part of the handwritten text selected by the processing object block selection part 307. The recognition processing part 308 executes a character recognition processing with respect to a portion corresponding to a character among strokes, a table recognition processing with respect to a portion corresponding to a table among the strokes, and a graphic recognition processing with respect to a portion corresponding to a graphic among the strokes. The recognition processing part 308 can perform the character recognition processing with respect to a stroke(s) contained in each cell of a table to thereby output a symbol(s) corresponding to the stroke(s). The symbols contain characters, numerals, marks, mathematical symbols, map symbols etc., and may be any type so long as the symbol can be associated with any code in the computer. The recognition processing part 308 executes the shaping processing in accordance with an operation by a user for shaping a handwritten text. The operation for shaping a handwritten text (hereinafter referred to a shaping operation) may be performed in response to the selection of a “forming” menu by a user, or a gesture performed by a hand of a user or the pen, for example.

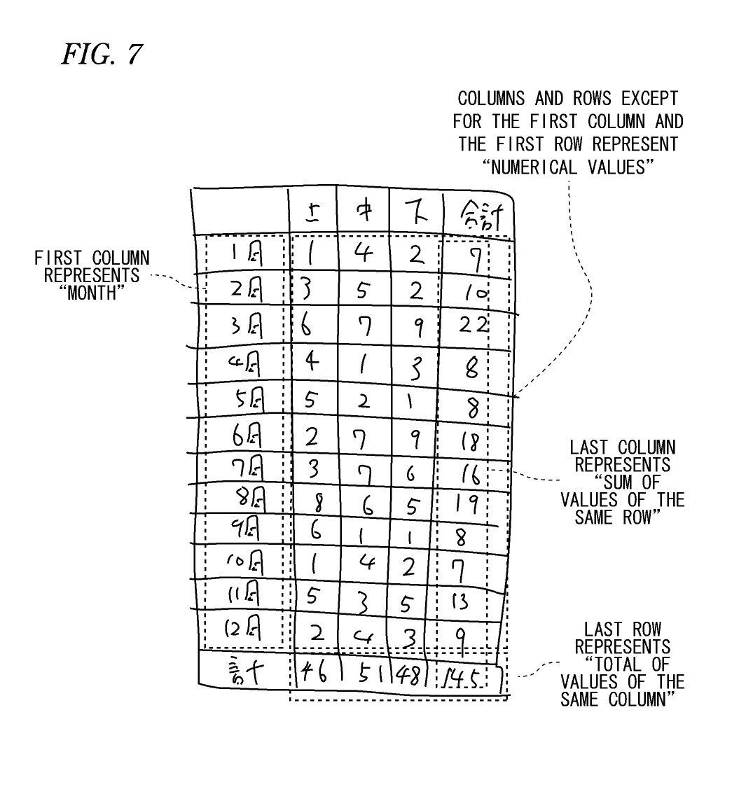

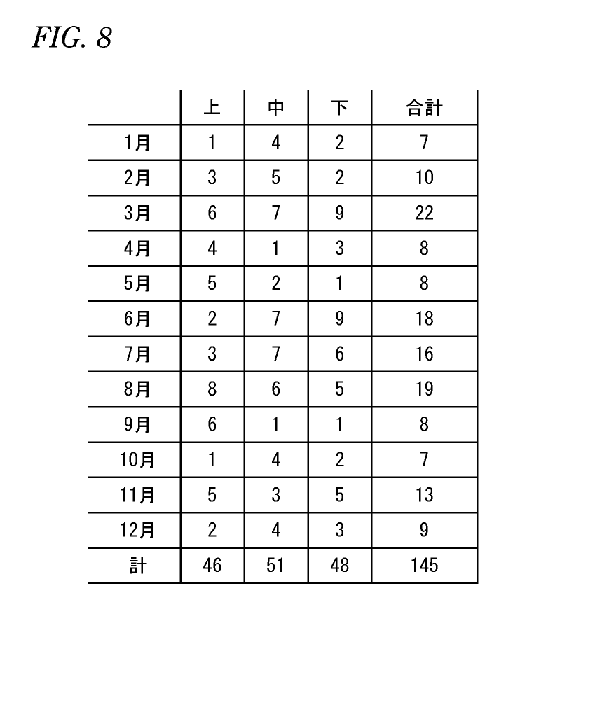

FIGS. 7 and 8 are diagrams showing an example of a handwritten text, and an example of the shaping result of the handwritten text, respectively. In each of these figures, the first row represents the titles (top, middle, bottom, sum) of respective columns, the second to thirteenth rows respectively represent breakdowns and sums from January to December, and the last row represents the total values of the breakdowns and sums from the second row to the thirteenth row. The first column represents the titles (January to December, total) of respective rows. The second to fourth columns represent breakdowns and sums of the top, middle and bottom, respectively. The last column represents the sum values from the second to fourth columns.

In the case of executing the recognition processing as to one cell (first cell) within the table, the recognition processing part 308 executes the recognition processing using a set of stroke(s) contained within another cell in the same column or row as that of the first cell as well as a set of stroke(s) (set of first stroke(s)) contained within the first cell. At the time of executing the recognition processing as to the set of first stroke(s) contained within the first cell, the recognition processing part 308 may obtain plural candidates corresponding to the recognition result of the set of first stroke(s). The recognition processing part 308 can narrow down the plural candidates corresponding to the recognition result of the set of first stroke(s) into one by using the set of stroke(s) contained within the another cell in the same column or row as that of the first cell.

For example, “1 [symbol] ” (which is a Japanese to indicate “a 1st day” and which shape is similar to the shape of “1 [symbol] ”) may be obtained as a candidate of an erroneous recognition result as to a set of strokes “1 [symbol] ” (which is a Japanese to indicate “January”) within the cell at the second row, first column of the table in FIG. 7. Also, “ [symbol] ” (which is a combination of Japanese “ [symbol] ” and “ [symbol] ” which shape is similar to the shape of “1 2 [symbol] ”) may be obtained as a candidate of an erroneous recognition result as to a set of strokes” 1 2 [symbol] “(which is a Japanese to indicate “December”) within the cell at the thirteenth row, first column of the table. Since each of the cells from the second row to the thirteenth row at the first column in the table of FIG. 7 is formed by the combination of “numerical number” and “ [symbol] ” (which is a Japanese to indicate “month”), the recognition processing part 308 can narrow down the candidates “1 [symbol] ” and “1 [symbol] ” as the recognition result as to the set of strokes within the cell at the second row, first column into the correct recognition result “1 [symbol] ”. Similarly, the recognition processing part can narrow down the candidates “1 2 [symbol] ” and “ [symbol] ” as the recognition result as to the set of strokes within the cell at the thirteenth row, first column into the correct recognition result “1 2 [symbol] ”.

Further, for example, “ [symbol] ” and “ [symbol] ” (which are Japanese katakana scripts and which shape is similar to the shape of “7”) may be obtained as candidates of an erroneous recognition result as to a set of strokes “7” within the cell at the seventh row, third column and the cell at the second row, fifth column, for example. Also, “G” may be obtained as a candidate of an erroneous recognition result as to a stroke “6” within the cell at the fourth row, second column and the cell at the eighth row, fourth column, for example. Also, “B” may be obtained as a candidate of an erroneous recognition result as to a set of strokes “13” within the cell at the twelfth row, fifth column. Since each of the cells from the second row, second column to the fourteenth row, fifth column is formed by “numerical number”, the recognition processing part 308 can narrow down the candidates “7”, “ [symbol] ” and “ [symbol] ” as the recognition result as to the set of strokes within the cell at the seventh row, third column and the cell at the second row, fifth column etc. into the correct recognition result “7”. Similarly, the recognition processing part can narrow down the candidates “6” and “G” as the recognition result as to the set of strokes within the cell at the fourth row, second column and the cell at the eighth row, fourth column etc. into the correct recognition result “6”. Further similarly, the recognition processing part can narrow down the candidates “13” and “B” as the recognition result as to the set of strokes within the cell at the twelfth row, fifth column into the correct recognition result “13”.

In the aforesaid example, when the recognition processing is executed as to the set of first stroke(s) contained within the first cell without using a set of stroke(s) contained within another cell in the same column or row as that of the first cell, the recognition processing part 308 may recognize the set of first stroke(s) erroneously as (“1 [symbol] ”, “ [symbol] ”, “ [symbol] ”, “ [symbol] ”, “G”, “B”). However, even in such the case, the recognition processing part 308 can perform the correct recognition of (“1 [symbol] ”, “1 2 [symbol] ”, “7”, “6”, “13”) as to the set of first stroke(s) contained within the first cell by using a set of stroke(s) contained within another cell in the same column or row as that of the first cell.

In the aforesaid example, although the recognition processing part 308 employs the regularity of “numerical number” and “numerical number+month” and the attribute of characters, the recognition processing part may further employ “name of month”, “day”, “alphabet”, “English word”, “Greek alphabet”, “continuous numerical numbers of constant digit” etc. as a rule for narrowing down the candidates of the recognition result.

In the case of executing the recognition processing as to the first cell, the recognition processing part 308 can execute the recognition processing by using a mathematical relation (mathematical formula) between a value corresponding to the set of first stroke(s) of the first cell and a value corresponding to a set of stroke(s) contained within another cell in the same column or row as that of the first cell. For example, the recognition processing part 308 can execute the recognition processing by using a fact that the sum of values of the second, third and fourth columns is same as a value of the fifth column with respect to the same row in the table of FIG. 7 or a fact that the sum of values of the second row to the thirteenth row is same as a value of the fourteenth row with respect to the same column in the table. The mathematical relation (mathematical formula) between a value corresponding to the set of first stroke(s) of the first cell and a value corresponding to a set of stroke(s) contained within another cell in the same column or row as that of the first cell can be specified by a four arithmetic operations (addition, subtraction, multiplication and division) etc. The recognition processing part 308 can narrow down plural candidates of the recognition result of the fifth column into one satisfying the specified mathematical relation (mathematical formula) by using the fact that the sum of values of the second, third and fourth columns is same as a value of the fifth column with respect to the same row in the table of FIG. 7. Also, the recognition processing part can narrow down plural candidates of the recognition result of the fourteenth row into one satisfying the specified mathematical relation (mathematical formula) by using the fact that the sum of values of the second row to the thirteenth row is same as a value of the fourteenth row with respect to the same column in the table. The recognition processing part 308 can add “ [symbol] ” (which is a Japanese to indicate “sum”) and “ [symbol] ” (which is a Japanese to indicate “total”) even if a set of strokes “ [symbol] [symbol] ” (sum) and a set of strokes “ [symbol] ” (total) are not handwritten within the cell at the first row, fifth column and the cell at the fourteenth row, first column, respectively, by using the fact that the sum of values of the second, third and fourth columns is same as a value of the fifth column with respect to the same row in the table of FIG. 7 or the fact that the sum of values of the second row to the thirteenth row is same as a value of the fourteenth row with respect to the same column in the table.

In the case of executing the recognition processing as to the first cell, the recognition processing part 308 can execute the recognition processing by using a set of stroke(s) contained within a head cell in the same column as that of the first cell or a head cell in the same row as that of the first cell as well as a set of stroke(s) contained within the first cell.

For example, the recognition processing part 308 can execute the recognition processing in a manner that each cell of the fifth column can be estimated as representing a “numerical number” from the set of strokes “ [symbol] ” (sum) within the cell at the first row, fifth column in the table of FIG. 7 and that the cell of the fourteenth row can be estimated as representing a “numerical number” from the set of strokes “ [symbol] ” (total) within the cell at the fourteenth row, first column in the table.

Further, for example, the recognition processing part 308 can execute the recognition processing by using a fact that a value of the fifth column can be estimated as the sum of values of the second, third and fourth columns with respect to the same row in the table of FIG. 7 from the set of strokes “ [symbol] ” (sum) within the cell at the first row, fifth column in the table. Also, the recognition processing part can execute the recognition processing by using a fact that a value of the fourteenth row can be estimated as the sum of values of the second row to the thirteenth row with respect to the same column in the table from the set of strokes “ [symbol] ” (total) within the cell at the fourteenth row, first column in the table.

The recognition processing part 308 can detect a miscalculation of a value described as the set of first strokes in the first cell when a mathematical relation (mathematical formula) between a value corresponding to the set of first stroke(s) of the first cell and a value corresponding to a set of stroke(s) contained within another cell in the same column or row as that of the first cell can be specified. The recognition processing part 308 may automatically correct the miscalculation value in the fifth column or the fourteenth row or may notify a user of the miscalculation, when a value of the fifth column does not coincide with the sum of values of the second, third and fourth columns with respect to the same row in the table of FIG. 7 or when a value of the fourteenth row does not coincide with the sum of values of the second row to the thirteenth row with respect to the same column in the table.

The recognition processing part 308 can automatically estimate and write a value of a vacant cell when the mathematical relation (mathematical formula) between a value corresponding to the set of first stroke(s) of the first cell and a value corresponding to a set of stroke(s) contained within another cell in the same column or row as that of the first cell can be specified. When the cells of the fifth column or the cells of the fourteenth row in the table of FIG. 7 contain a vacant cell, the recognition processing part 308 may automatically fill a value in the vacant cell or may notify a user of the presence of the vacant cell or an estimated value thereof.

The recognition processing part 308 can interpolate a missing part of a set of stokes within a cell, by using a relation between the attribute of a symbol corresponding to a set of first stroke(s) of the first cell and the attribute of a symbol corresponding to a set of stroke(s) contained within another cell in the same column or row as that of the first cell. For example, since each of the cells in the first column in the table of FIG. 7 is formed by “numerical number+ [symbol] ”, even when “ [symbol] ” (month) is missed in each of the cells from the eighth to thirteenth rows of the first column in the manner of “7”, “8”, “9”, “10”, “11” and “12”, the recognition processing part 308 can interpolate these cells to read “7 [symbol] ”, “8 [symbol] ”, “9 [symbol] ”, “1 0 [symbol] ”, “1 1 [symbol] ” and “1 2 [symbol] ”.

When the mathematical relation (mathematical formula) can be specified between a value corresponding to the set of first stroke(s) of the first cell and a value corresponding to a set of stroke(s) contained within another cell in the same column or row as that of the first cell, the recognition processing part 308 can use the recognition result of the set of first stroke(s) of the first cell as a mathematical formula for calculating a character recognition result of the set of first stroke(s) of the first cell. For example, in the table of FIG. 7, by using the fact that the sum of values of the second, third and fourth columns is same as a value of the fifth column with respect to the same row or the fact that the sum of values of second row to thirteenth row is same as a value of the fourteenth row with respect to the same column, a mathematical formula “=sum (xx:xx)” may be written as the recognition result into the cell of the fifth column in place of writing “a numerical value” as the character recognition result.

The recognition processing part 308 can set the recognition result of a set of strokes of one cell as non-deletable and the recognition result of a set of strokes of another cell as deletable, by using the set of first stroke(s) of the first cell and a set of stroke(s) contained within another cell in the same column or row as that of the first cell. For example, when cells each representing the title are specified by using the set of first stroke(s) of the first cell and a set of stroke(s) contained within another cell in the same column or row as that of the first cell, the recognition processing part 308 may add a flag for inhibiting the deletion to the recognition result of a set of strokes corresponding to the title and add a flag for enabling the deletion to the recognition result of a set of strokes not corresponding to the title. For example, in the table of FIG. 7, since each cell of the first row is formed by “a character sequence”, the recognition processing part 308 can estimate that the first row represents the titles (top, middle, bottom, sum) of the respective columns. Also, since each cell of the first column is formed by “numerical number+month”, the recognition processing part can estimate that the first column represents the titles (from January to December, total) of the respective rows. The recognition processing part 308 adds a flag for inhibiting the deletion to each of the recognition result of strokes corresponding to the lines of the table and the recognition result of the set of strokes of each of the cells of the first row and the first column corresponding to the titles, and also adds a flag for enabling the deletion to the recognition result of the set of strokes of each of the cells not corresponding to the title. In this manner, a template capable of being used repeatedly hereinafter upon handwriting can be generated easily.

The recognition processing part 308 executes the aforesaid recognition processing in accordance with the shaping operation and outputs the recognition result to the LCD 17A. When the shaping operation is performed while the entirety of a single page of a handwritten text is selected by the processing object block selection part 307, the recognition processing part 308 outputs to the LCD 17A the recognition result of the entirety of the single page of the handwritten text in place of the single page of the handwritten text. The LCD 17A may display thereon both the entirety of the single page of the handwritten text and the recognition result thereof or may display one of them in a switchable manner. When the shaping operation is performed while a part of a single page of a handwritten text is selected by the processing object block selection part 307, the recognition processing part 308 outputs to the LCD 17A the recognition result of the part of the single page of the handwritten text in place of the strokes of the part of the single page of the handwritten text. The LCD 17A may display thereon both the part of the single page of the handwritten text and the recognition result thereof or may display one of them in a switchable manner.

When the recognition processing part 308 automatically corrects or adds a recognition result or adds a stroke(s) as described above, the recognition processing part may also output information for changing a display mode of the corrected or added portion. The recognition result corrected or the strokes added automatically by the recognition processing part 308 may be displayed in a display mode different (different color, different kind of line, different thickness etc.) from that of the recognition result of other strokes, or may be displayed together with a handwritten stroke(s), or may be displayed in a switchable manner between the recognition result and the handwritten stroke(s). The recognition processing part 308 may also output, in addition to the recognition result of a handwritten table, a graph(s) (a bar graph(s), a line graph(s) etc.) suitable for the table.

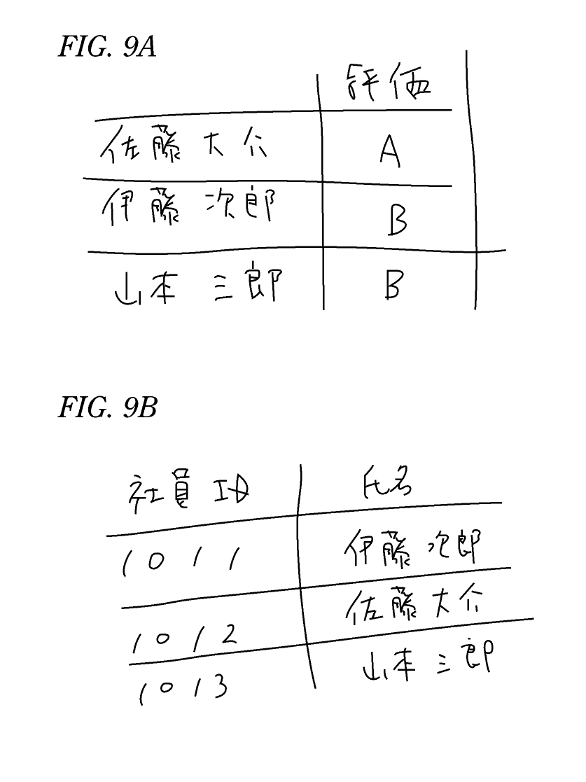

FIGS. 9A and 9B are diagrams showing an example of a handwritten text. The handwritten text of FIG. 9A includes a table (hereinafter referred to an estimation table) associating Japanese names of “ [symbol] ”, “ [symbol] ”, “ [symbol] ” and appraisals of “A”, “B”, “B.” And, the handwritten text of FIG. 9B includes a table (hereinafter referred to an employee table) associating employee IDs of “1011”, “1012”, “1013” and the Japanese names of “ [symbol] [symbol] ”, “ [symbol] ”, “ [symbol] ”.

The recognition processing part 308 executes a recognition processing in the similar manner as the aforesaid case by using a fact that each of the cells from the second row, first column to the fourth row, first column of the estimation table is formed by “a character sequence”, a fact that each of the cells from the second row, second column to the fourth row, second column of the estimation table is formed by “an alphabet”, a fact that the cell at the first row, second column is formed by “a title”, a fact that each of the cells from the second row, first column to the fourth row, first column of the employee table is formed by “a sequence of numerical numbers”, a fact that each of the cells from the second row, second column to the fourth row, second column of the employee table is formed by “a character sequence”, and a fact that each of the cells at the first row, first column and the first row, second column of the employee table is formed by “a title”.

When it is specified that a value corresponding to a set of first strokes of the first cell relates to another information (another table, database, Web page etc.), the recognition processing part 308 can add information relating to a link to said another information to the recognition result corresponding to the set of first strokes of the first cell. For example, when it is detected that there is a similar entry to the employee table with respect to the recognition result of “ [symbol] [symbol] ”, “ [symbol] ”, “ [symbol] ” from the second row, first column to the fourth row, first column of the employee table, the recognition processing part 308 can add the information relating to a link to the employee IDs etc. of the employee table. When a handwritten stroke connecting the first column of the estimation table and the second column of the employee table is written, the recognition processing part 308 may add information relating to a link to the employee IDs etc. of the employee table with respect to the recognition result of “ [symbol] ”, “ [symbol] ”, “ [symbol] ” from the second row, first column to the fourth row, first column of the employee table. When a relation to another table, database, Web page etc. is inputted from a user, the recognition processing part 308 may add information relating to a link to other information with respect to the recognition result.

In this manner, according to the first embodiment, in the case of executing the recognition processing with respect to a single cell (first cell) within the table, the recognition processing is executed by using a set of stroke(s) contained within another cell in the same column or row as that of the first cell as well as a set of stroke(s) (set of first stroke(s)) contained within the first cell. According to this processing, in the case of recognizing a table handwritten on a handwritable tablet as digital data of the table, for example, erroneous recognition of characters can be suppressed and hence a work for converting/shaping the table can be improved largely.

In the aforesaid example, the explanation is made as to the mode that the recognition processing part 308 executes the recognition processing of the handwritten table when the shaping operation is performed. However, even if a particular operation (shaping operation, for example) is not performed by a user, the recognition processing part 308 may execute the recognition processing in real time when a text is inputted in a handwritten manner by the user. In this case, a handwritten text displayed on the LCD 17A may be replaced by the recognition result in real time or may be merely placed in a state of being replaceable by the recognition result.

Although the explanation is made that the digital notebook application program 202 and the respective functional blocks are executed by the CPU 101, this invention is not limited thereto. The processing of the recognition processing part 308 may be executed by the processor within the personal computer 1 or the processor within the server 2. In this case, the tablet 10 may send stroke data subjected to the recognition processing to the personal computer 1 or the server 2.

The processing of each of the pen locus display processing part 301, the chronological information generation part 302, the edition processing part 303, the page storage processing part 304, the page acquisition processing part 305, the handwritten text display processing part 306, the processing object block selection part 307 and the recognition processing part 308 etc. may be executed by the processor within the personal computer 1 or the processor within the server 2. In this case, the tablet 10 may transmit information such as the event detected by the touch screen display 17 and information such as the operation of the edition menu by a user to the personal computer 1 or the server 2, and further may receive image information showing the final processing result therefrom.

The respective functional blocks of the digital notebook application program 202 other than the chronological information generation part 302 and the handwritten text display processing part 306 may be executed by the processor within the personal computer 1 or the processor within the server 2. In this case, the tablet 10 may transmit the chronological information inputted by a user and information such as the operation of the edition menu to the personal computer 1 or the server 2.

In this manner, when at least one of the functional blocks of the digital notebook application program 202 is executed by the processor within the personal computer 1 or the processor within the server 2, the work memory 401 and the storage medium 402 may be realized by at least one of the storage device within the tablet 10, the storage device within the personal computer 1 and the storage device within the server 2.

This invention is not limited to the aforesaid embodiment as it is and can be realized by modifying the constituent elements thereof in various manners without departing from the gist of the invention at the time of implementing the invention. Further, various modifications of the invention can be achieved by suitably combining the constituent elements disclosed in the aforesaid embodiment. Furthermore, some of the entire constituent elements shown in the embodiment may be deleted, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input configured to receive information of a handwritten table, cells in the table including strokes; and
a display controller configured to display either one of a first symbol and a second symbol as a recognition result of a first stroke in a first cell of the table at a position of the first cell in response to an operation for formatting the table,
wherein one of the first symbol and the second symbol is determined to be displayed according to one of at least one of second strokes in another cell in a same row as the first cell and at least one of third strokes in another cell in a same column as the first cell.

2. The electronic device of claim 1,
wherein the first symbol is determined as a first recognition result of the first stroke when none of the second strokes and the third strokes are used, and
the second symbol is determined as a second recognition result of the first stroke when one of the second strokes and the third strokes is used.

3. The electronic device of claim 1,
wherein the second symbol is based on information relating to a mathematical formula for calculating a character recognition result of the second symbol.

4. The electronic device of claim 1,
wherein the second symbol is based on information relating to a link to other information associated with the second symbol.

5. The electronic device of claim 1,
wherein the second symbol is based on information used for determining whether or not a deletion is executed in a case of executing a deletion processing.

6. The electronic device of claim 1, further comprising:
a touch screen display,
wherein data of the table described in the handwritten manner is inputted via the touch screen display, and
the display controller displays one of the first symbol and the second symbol at the position of the first cell on the touch screen display.

7. A method comprising:
receiving information of a handwritten table, cells in the table including strokes; and
displaying either one of a first symbol and a second symbol as a recognition result of a first stroke in a first cell of the table at a position of the first cell in response to an operation for formatting the table,
wherein one of the first symbol and the second symbol is determined to be displayed according to one of at least one of second strokes in another cell in a same row as the first cell and at least one of third strokes in another cell in a same column as the first cell.

8. The method of claim 7,
wherein the first symbol is determined as a first recognition result of the first stroke when none of the second strokes and the third strokes are used, and
the second symbol is determined as a second recognition result of the first stroke when one of the second strokes and the third strokes is used.

9. The method of claim 7,
wherein the second symbol is based on information relating to a mathematical formula for calculating a character recognition result of the second symbol.

10. The method according to claim 7,
wherein the second symbol is based on information relating to a link to other information associated with the second symbol.

11. The method according to claim 7,
wherein the second symbol is based on information used for determining whether or not a deletion is executed in a case of executing a deletion processing.

12. A non-transitory computer-readable medium storing a program that causes an electronic device to execute a control processing comprising:
receiving information of a handwritten table, cells in the table including strokes; and
displaying either one of a first symbol and a second symbol as a recognition result of a first stroke in a first cell of the table at a position of the first cell in response to an operation for formatting the table,
wherein one of the first symbol and the second symbol is determined to be displayed according to one of at least one of second strokes in another cell in a same row as the first cell and at least one of third strokes in another cell in a same column as the first cell.

13. The computer-readable medium of claim 12,
wherein the first symbol is determined as a first recognition result of the first stroke when none of the second strokes and the third strokes are used, and
the second symbol is determined as a second recognition result of the first stroke when one of the second strokes and the third strokes is used.

14. The computer-readable medium of claim 12,
wherein the second symbol is based on information relating to a mathematical formula for calculating a character recognition result of the second symbol.

15. The computer-readable medium of claim 12,
wherein the second symbol is based on information relating to a link to other information associated with the second symbol.

16. The computer-readable medium of claim 12,
wherein the second symbol is based on information used for determining whether or not a deletion is executed in a case of executing a deletion processing.
